(19) United States
(12) Patent Application Publication
(10) Pub. No.: US 2014/0230658 A1
(43) Pub. Date: Aug. 21, 2014

(54) HOT BEVERAGE PRODUCTION DEVICE

(71) Applicant: NESTEC S.A., Vevey (CH)

(72) Inventors: Matthieu Ozanne, Publier (FR); Didier Vuagniaux, Gimel (CH)

(21) Appl. No.: 14/347,144

(22) PCT Filed: Sep. 26, 2012
(86) PCT No.: PCT/EP2012/068988

§ 371 Date: Mar. 25, 2014

(30) Foreign Application Priority Data
Sep. 26, 2011 (EP) 11182702.8

(51) Int. Cl. A47J 31/46

(52) U.S. Cl. CPC A47J 31/46
USPC 99/300

(57) ABSTRACT

The invention concerns a beverage production device comprising:—a beverage production chamber (1) designed to have a liquid interact with a beverage ingredient,—a pump (2) for pumping the liquid,—a heater (3) for heating the pumped liquid, wherein the heater comprises:—a chamber (31) presenting an inlet (32) for the introduction of the liquid and an outlet (33) for the discharge of the liquid,—a heating body (34) contained in the chamber, characterised in that the liquid outlet (33) is placed at the top side (310) of the heater chamber (31), and the chamber of the heater comprises an outlet (35) for the discharge of air, said air outlet being arranged at a position higher than the liquid outlet (33) with respect to the horizontal.

### FIELD OF THE INVENTION

The present invention relates to a beverage production device for preparing a beverage from a beverage ingredient and hot water. More particularly, the invention relates to such a device in which water is heated and made to interact with a beverage ingredient in a beverage production chamber, the beverage ingredient particularly being contained in pre-portioned form in a closed capsule.

### BACKGROUND OF THE INVENTION

Devices for preparing a beverage by injecting, for instance, pressurized fluid to a capsule are well-known, especially in the field of producing tea, coffee or coffee type beverages. In addition, other substances such as chocolate or milk products can be extracted or dissolved to form a beverage. The advantages of such a system are in particular the conservation and freshness of the ingredients, as well as the possibility of facilitating the operations when preparing the beverage.

It should be understood that the interaction between the liquid and the ingredients within, for example, the capsule can be e.g. dissolving, extraction, brewing or any other interaction in order to prepare a beverage by means of ingredients provided within the capsule. Such a capsule is yet known from the patent documents WO 2007/042414 A1 and WO 2008/025730 A1 and mainly comprises an enclosure defined by a housing or shell and a filtering means.

When, for instance, preparing tea in such a device a problem occurs due to the presence of air in the liquid (e.g. water) being delivered to the capsule. This air mainly comes from the heating of the water which is carried out by a heater provided in the supply means for supplying the liquid to the beverage production chamber of the device. The air or air bubbles appear as soon as the liquid (water) temperature reaches about 70° C. The air is thus introduced with the liquid into the capsule but tends to not traverse the filter means (generally a paper filter) that is placed inside the capsule as described above. As in a low pressure water flow, which is present when preparing e.g. tea, there is no important stirring of water and of the product to be brewed (beverage ingredient like powder), the air bubbles can separate from the liquid, slowly raise to the top of the beverage production chamber like a capsule, for instance, and stay behind the filter inside the capsule. Their volume grows as long as water is injected inside the capsule. However, this volume can become so important that, for instance, the tea leaves are no longer properly immersed inside the liquid (water) and the tea can thus be not sufficiently extracted.

The elimination of air from the fluid system presents also the advantage of improving the priming of the pump.

WO 2009/135899 proposes a solution to this problem consisting in treating hot water issued from the heater and containing air in an air separating device before introducing the hot water in the capsule. The air separating device consists in a labyrinth in which the kinetic energy of the hot water is broken enabling the separation of air from water.

Although this solution is efficient, this air separating device represents a certain cost and increases the cost of the final beverage machine. Moreover, it increases the size of the machine.

There is therefore a need for an alternative solution for discharging air from hot water that is less costly.

### SUMMARY OF THE INVENTION

The invention concerns a beverage production device comprising:
a beverage production chamber designed to have a liquid interact with a beverage ingredient,
a pump for pumping the liquid,
a heater for heating the pumped liquid, wherein the heater comprises :
   a chamber presenting an inlet for the introduction of the liquid and an outlet for the discharge of the liquid,
   a heating body contained in the chamber,
      and wherein :
the liquid outlet is placed in or near the top side of the heater chamber, and
the chamber of the heater comprises an outlet for the discharge of air, said air outlet being arranged at a position higher than the liquid outlet with respect to the horizontal.

The beverage production device comprises a pump which generally pumps cold liquid, preferably cold water, from a liquid source like a tank. The pump provides the pumped water to the heater for heating the liquid.

The heater comprises a chamber in which the liquid is introduced for heating. The chamber comprises an inlet for the introduction of the cold pumped liquid. The chamber comprises an outlet for the discharge of the hot pumped liquid. The liquid outlet is connected directly or indirectly to the beverage production chamber. According to the invention the liquid outlet is placed in or near the top side of the heater chamber. Preferably the outlet is positioned substantially on the external periphery of the heater chamber top side. The inlet can be placed in any part of the chamber. Preferably the air outlet and the liquid outlet of the heater chamber are sufficiently distant so that air cannot be sucked by the water flow through the water outlet.

According to the invention the heater also comprises an outlet for discharging air. This air outlet can be connected to a waste compartment or a breather means. The air outlet is arranged in the heater chamber at a position higher than the liquid outlet with respect to the horizontal. As air contained in the pumped liquid is lighter than liquid (e.g. water) and thus rises to an upper portion of the chamber, it can easily be evacuated from the chamber while the liquid can be evacuated through the liquid outlet arranged at a lower position. Hence, air is prevented from being introduced in the liquid outlet and sent to the beverage production chamber. Most preferably the air outlet is positioned at the highest vertical point of the chamber.

According to a first embodiment, the heater chamber is tilted so that the air outlet is at a position higher than the liquid outlet with respect to the horizontal. Preferably the heater chamber is tilted so that the air outlet is at or near the highest position of the heater chamber when the heater chamber is fixed in the beverage production device. The heater chamber can be tilted so that its longitudinal axis presents an angle with the vertical axis of at least 1 °, preferably at least 5°, and even more preferably comprised between 5° and 20°. Generally the heater chamber presents an essentially cylindrical shape. Usually the air outlet and the liquid outlet are on the same side of the chamber, preferably on the same side.

According to a second embodiment, the chamber presents essentially the shape of a cylinder, said cylinder being truncated on at least its upper base, and the air outlet is positioned on said upper truncated base of the chamber cylinder. The cylinder is preferably positioned in the machine so that its longitudinal axis is vertical. The heater chamber cylinder can be truncated by a plan presenting an angle a with the plan perpendicular to the chamber longitudinal axis of at least 1°, preferably at least 5°, and even more preferably comprised between 5° and 20°.

The advantage of the two above preferred embodiments is that all the air bubbles of the heated liquid automatically flow up and converge to one point that is the highest point of the chamber that can be the corner between two walls of the chamber.

The time of residence of the liquid in the chamber is preferably sufficiently long for simultaneously enabling the heating of the cold liquid and the separation of the air from the liquid. This residence time can be controlled by the length of the liquid path in the heater chamber, consequently the liquid inlet and the liquid outlet of the heater chamber are usually positioned at opposite parts of the chamber, preferably in opposite sides of the chamber. According to the preferred embodiment the liquid inlet is placed in the bottom of the heater chamber. Usually the heater is positioned in the beverage production device so that it presents a top and a bottom side and the liquid inlet is in the heater chamber bottom side and the liquid outlet is in the heater chamber top side. The residence time of the liquid can be also be controlled by the size of the internal volume of the heater chamber. It can also be controlled by the value of the flow of the liquid entering in the chamber.

A heating body is contained in the chamber in order to contact the pumped liquid and transfer its heat to the liquid. Usually the heating body is resistive elements, preferably put in the form of a spiral or a helicoid, embedded in a heat conductive matrix. According to a preferred embodiment the heating body has the shape of a spiral and the heater chamber can be hollowed along its central axis so as to form a ring in which the spiral fits.

Preferably the process for using the heater is configured for not producing steam but only hot water presenting a temperature of at most 90° C.

Preferably the liquid outlet of the heater chamber is connected to a liquid valve and the air outlet of the heater chamber is provided with a air valve. By means of the liquid valve, the value of the pressure at which the valve is opened can be set to a liquid pressure needed for the liquid to be supplied to the beverage production chamber and for beverage production. This valve can be placed either directly at the outlet of the heater chamber or downstream near from the beverage production chamber. By means of the air valve, sufficient deaeration of the liquid can be attained without any liquid escaping through said valve. Preferably the value of pressure for opening the liquid valve is greater than that of the air valve. Then deaeration can already be accomplished before liquid is evacuated from the heater chamber. Hence, the chance of separated air to be mixed again with airless liquid is reduced and thus, the liquid being supplied to the beverage production chamber merely contains a minimum of air or other gas. The value of pressure for opening the first valve can be at least 0,2 bar, preferably at least 0,4 bar. Thus, the liquid is supplied to the beverage production chamber at an appropriate pressure for beverage production.

According to another preferred aspect of the invention, the heater is provided with a temperature sensor. Said temperature sensor can be placed near or in the heater chamber outlet tube. Then the temperature of the liquid flowing out of the liquid heater can be directly measured by the sensor: the sensor is immersed in the liquid flow. Preferably the heating body of the chamber is operatively connected to the temperature sensor. The pump can also be operatively connected to the temperature sensor: the operative connection consists in activating the pump only when the temperature sensor indicates that the temperature of the liquid at the outlet of the heater chamber reaches the temperature set for preparing a beverage.

The invention also concerns a particular embodiment of the heater wherein:
the air outlet is provided with an air valve,
the heater is provided with a temperature sensor,
the heating body has the shape of a spiral and the heater chamber is hollowed along its central axis so as to form a ring in which the spiral fits, and
   and wherein the heater comprises a common bracket for attaching an outlet connector to the beverage production chamber, the air valve and the temperature sensor to the heater chamber.

The beverage production chamber of the device of the present invention is generally a brewing chamber configured to receive an infusable food ingredient and hot water. In the brewing process, the heated water infuses and extracts flavours from the brewing substance. The brewing chamber can contain a filter means to allow beverage to drain from the infused food ingredient and water mixture. It can be configured to be hermetically closed to receive and hold the diluent under pressure and to retain the infusable food ingredient. The infusable food ingredient can be roast and ground coffee, tea leaves, herbs, botanicals, as well as other substances. It is preferably tea leaves. According to the preferred embodiment the beverage production chamber is configured for receiving a capsule containing the beverage ingredient, the capsule comprising an enclosure and a filtering wall, the filtering wall being vertically oriented.

In the present application the terms “top” and “bottom”, “upper” and “lower” are used to describe the relational positioning of features of the invention. These terms should be understood to refer to the heater in its normal orientation when inserted in the beverage production device as shown for example in FIGS. 1 to 4.

### BRIEF DESCRIPTION OF THE DRAWINGS

The characteristics and advantages of the invention will be better understood in relation to:

FIG. 1 which is a schematic diagram of the fluid system of a beverage dispenser according to the present invention,

FIG. 2 which is a schematic diagram of the fluid system of a beverage dispenser according to an alternative.

FIG. 3 is vertical section of a heater configured to be used in a beverage production device according to the present invention.

FIG. 4 is a perspective view of the heater of FIG. 3,

FIG. 5 is a perspective view of the bracket of the heater of FIG. 4,

FIG. 6 is a perspective view of the assembly of the bracket of FIG. 5 and other elements of the heater.

### DETAILED DESCRIPTION OF THE DRAWINGS

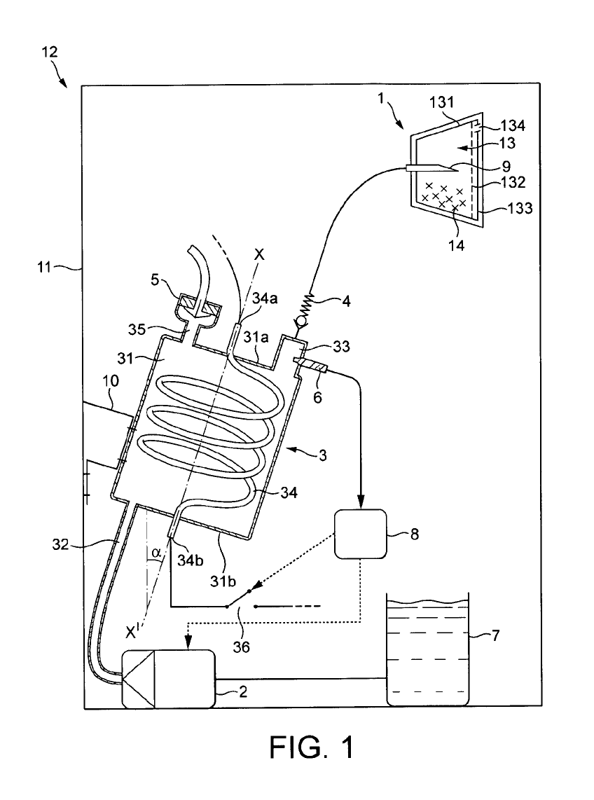

FIG. 1 shows a preferred embodiment of a beverage production device according to the present invention comprising a beverage production chamber 1 in which an injection member 9, preferably a needle, introduces a hot liquid. The beverage production device 12 of said embodiment further comprises a liquid reservoir 7, such as a water tank, a liquid pump 2, a heater 3 and a liquid supply line connecting these different devices. The beverage production device 1 also comprises a controller 8 to manage the beverage preparation cycles as known in the art. The pump 2 pumps the liquid from the reservoir 7 and introduces it in the chamber 31 of the heater 3 through an inlet 32 at the bottom side 31b of the chamber. The heater chamber comprises a heating body 34 that is a resistive element presenting the shape of a spiral. Yet the invention is not limited to this form of the heating body, other shapes could be used. The resistive element is connected to the electric power through electric supplies 34a, 34b placed at each extremity of the heating body. The chamber comprises a liquid outlet 33 at its top side 31a connected to the beverage production device 1. The chamber comprises also an air outlet 35 at its top side 31a. The heater is oriented so that the air outlet 35 is positioned above the liquid outlet 33 with respect to the horizontal. This orientation is obtained by leaning the boiler in the beverage production device so that the longitudinal axis XX′ of the boiler presents an angle a with the vertical axis. The longitudinal axis corresponds to the axis passing through the heater chamber bottom side and the heater chamber top side. In practice the specific orientation of the boiler can be obtained by fixing the heater 3 to the housing 11 of the beverage production device by means of a supporting element 10 configured for reaching this specific orientation. For example, the supporting element can be a bracket 10 presenting a part attached to the housing 11 of the beverage production device 12 and another part attached to the body of the heater 3, the two parts being oriented one relative to the other so as to lean the heater and have the air outlet arranged at a higher position than the liquid outlet.

The liquid outlet 33 is provided with a first valve 4. This valve can be of any known valve type used in such beverage production devices as, for instance, a check valve. Said valve is preferably designed such that it opens at a predetermined threshold pressure value. Said threshold pressure value for opening the first valve 4 can, for instance, be at least 0,2 bar, more preferably at least 0,4 bar. Hence, the liquid is supplied to the beverage production chamber 1 at an appropriate pressure for beverage production.

The air outlet 35 is provided with a second valve 5 for delivering air from the heater chamber to a waste compartment and/or a breather means. It has to be noted that the term “air” is used substantially for any kind of gases and is not limited to air. The second valve 5 is designed such it stays open when air is present in front of the valve but the valve 5 is closed immediately in case liquid appears. Such valve type is commonly known in the state of the art (cf. WO 02/088580 A1) and provides a sufficient deaeration without any liquid escaping through said valve. In a preferred embodiment of the invention the value of pressure for opening the first valve 4 is greater than the value of pressure for opening the second valve 5 such that deaeration can already be accomplished before liquid is evacuated from the chamber 31. Hence, the chance of separated air to be mixed again with airless liquid is reduced and thus, the liquid being supplied to the beverage production chamber 1 contains a minimum of air.

This valve also presents the advantage of enabling the priming of the pump of the beverage production device when it is used for the first time or further to its unpriming if the water tank is suddenly empty. Air in the pump and in the fluid pipes is evacuated through this valve.

The temperature of the liquid at the heater chamber outlet 33 is monitored by the control unit through a temperature sensor 6 placed in the liquid outlet; the control unit operates the heater body command 36 accordingly. The temperature sensor is also operatively linked to the pump: once the temperature is sufficient for producing a beverage, the controller activates the pump so that the hot liquid flows in the chamber outlet: the pressure in the chamber outlet raises until the pressure opening of the first valve 4 is reached and the valve opens.

Preferably the chamber presents an internal volume sufficient to dampen the flow of the liquid entering in it. Hence, it is possible to reduce the liquid flow velocity such that air or gas is not carried along inside the liquid by the speed of the liquid, and the air can thus rise in order to be evacuated by the air outlet, and the separation of air from the heated liquid is realised.

The beverage production chamber 1 is configured for receiving a capsule 13 comprising a beverage ingredient 14. The chamber 1 can comprise handling members for handling the capsule. The capsule mainly comprises an enclosure 131 containing the beverage ingredients 14 such as leaf tea and the like. The enclosure 131 is preferably demarcated by a cup-shaped housing and a filtering wall 132. The beverage production chamber 1 is preferably configured for holding the capsule in a vertical orientation that is with the filter 132 vertically oriented as illustrated in the figures. The capsule can be closed by a sealing wall 133 that overlaps the filtering wall. The sealing wall 133 can present a beverage outlet 134, preferably at an overflow location, or the chamber can be provided with a puncture element for opening an outlet 134 in the sealing wall, preferably at an overflow location of the enclosure 131. Due to the elimination of air and gases from the liquid in the heater, the air does not enter in the capsule and avoids that bubbles stagnate in the upper part of the capsule near from the outlet 134, avoiding a good beverage preparation. Notwithstanding the above description, the capsule 20 is not limited to any size or design, and there can also be used any other known beverage ingredient storage means or beverage production chambers also comprising a filter element for preparation of a beverage by extraction of beverage ingredients with heated liquids, preferably heated low-pressure liquids. In the following, liquid stands for all kinds of liquids for being used in a beverage production device as, for instance, water.

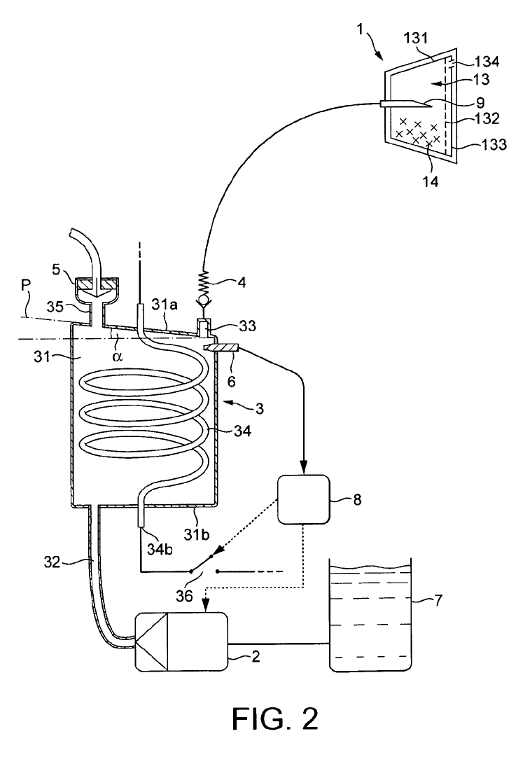

FIG. 2 shows an alternative embodiment of a beverage production machine of the present invention. The only difference with the machine of FIG. 1 is that the heater chamber is a cylinder presenting an upper base 31a that is truncated. The heater chamber cylinder is positioned with its longitudinal axis XX′ vertically oriented in the machine and the plan P of the truncated upper base 31a presents an angle α with the plan perpendicular to the longitudinal axis XX′, that is a horizontal plan in FIG. 2. This angle is of at least 1° with the horizontal, preferably at least 5°, and even more preferably comprised between 5° and 20°. The air outlet 35 is positioned at the highest position of the truncated upper base 31a.

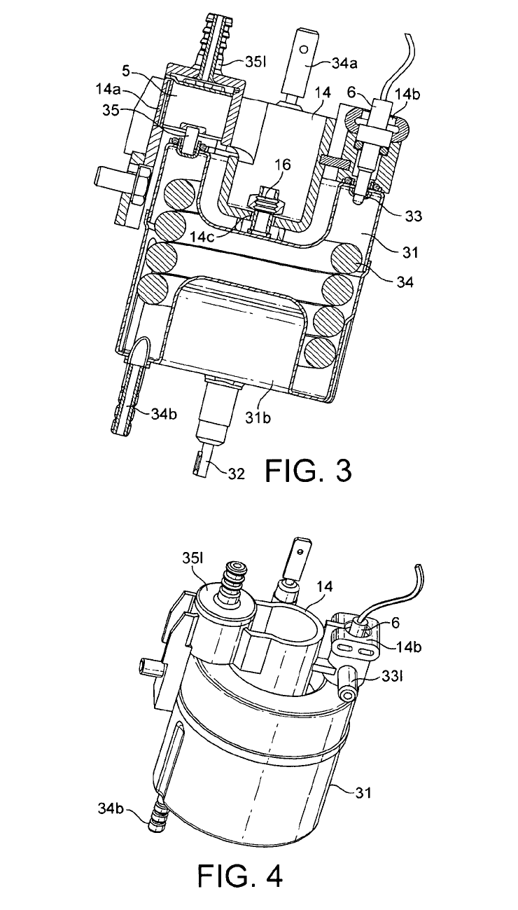

FIG. 3 shows a vertical section view of a heater that can be used according to the present invention. The same reference numbers are used for the parts identical in FIGS. 1 and 2. The heater chamber comprises a heating body 34 that is a resistive element presenting the shape of a spiral. The heater chamber 31 is hollowed along its central axis so as to form a ring in which the spiral of the heating body fits. The heater chamber 31 is hollowed by an upper hollowed part 31a and a bottom hollowed part 31b.

At the liquid outlet 33 of the chamber a temperature sensor 6 senses the temperature of water before it is delivered out of the heater. The chamber comprises also an air outlet 35 at its top side 31a. The air outlet 35 is provided with a second valve 5 for delivering air from the heater chamber. A cap 351 enables the connection to a downstream air tube.

For a quick connection during manufacturing the second valve 5, the temperature sensor 6 can be attached to the heater chamber by a common bracket 14. Said bracket can present three holes: a first one 14a in which the air valve 5 can fit, a second one 14b in which the temperature sensor 6 can fit and a third one 14c for attaching the bracket 14 to the chamber 31 e.g. with a screw 16.

FIG. 4 is a perspective view of the heater of FIG. 3 viewed from the above in order to illustrate the interaction of the bracket 14 with the heater chamber 31, the air valve 5, the temperature sensor 6 and the hot liquid connection 331 to the beverage production chamber. In this particular embodiment of FIGS. 3 to 6 the hot liquid connector 331 is part of the bracket 14. It guides water from the chamber outlet 33 to the rest of the fluid system. A first valve can be placed just downstream of said connector as illustrated in FIGS. 1 and 2.

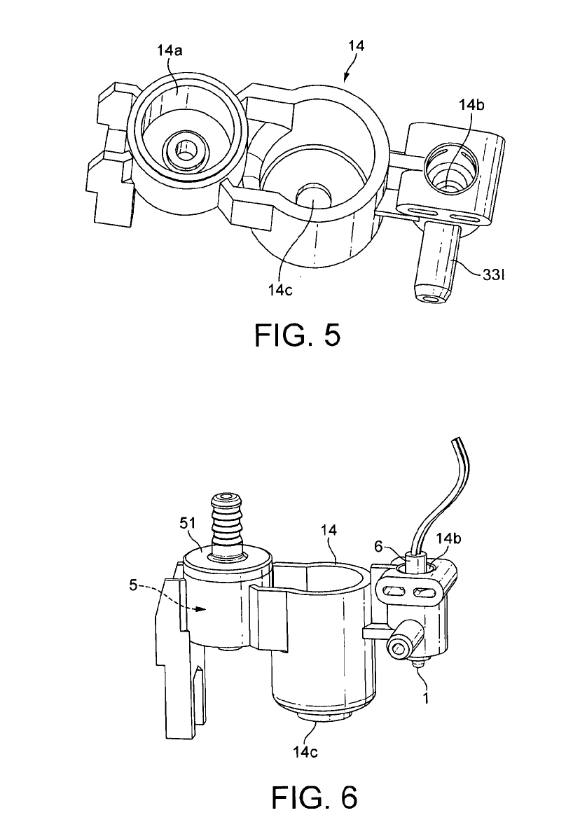

FIG. 5 is a perspective view of the bracket 14 alone enabling the identification of its different holes 14b, 14a, 14c for respectively introducing the temperatures sensor, the air valve and the screw for attachment to the heater chamber.

FIG. 6 is a perspective view of the bracket 14 with the temperature sensor 6 placed inside the hole 14b and the air valve 5 placed in the hole 14c with a cap 51 covering said valve and enabling the connection with a downstream pipe. It can be appreciated that during manufacturing these different elements can be firstly attached together and then the assembly of these elements can be easily fixed to the heater chamber by screw 16.

The device of the present invention presents the advantage of combining the functions of liquid heating and air discharging inside the single heater. Consequently, place is saved inside the beverage production device and the cost of production is lower.

1 beverage production chamber

2 pump

3 heater

31 heater chamber

31a heater chamber top side

31b heater chamber bottom side

32 heater liquid inlet

33 heater liquid outlet

331 liquid outlet connector

34 heating body

35 heater air outlet

36 heater command

4, 5 valve

6 temperature sensor

7 tank

8 controller

9 needle

10 supporting element

11 housing

12 beverage production device

13 capsule

131 capsule enclosure

132 filtering wall

133 sealing wall

134 beverage outlet

14 bracket

14a, 14b , 14c bracket holes

15a, 15b hollowed parts of the heater chamber

16 screw

1. A beverage production device comprising:
a beverage production chamber designed to have a liquid interact with a beverage ingredient;
a pump for pumping the liquid;
a heater for heating the pumped liquid, wherein the heater comprises:
a chamber comprising an inlet for the introduction of the liquid and an outlet for the discharge of the liquid;
a heating body located in the chamber;
the liquid outlet is located at a top side of the heater chamber; and
the chamber of the heater comprises an outlet for the discharge of air, the air outlet being located at a position higher than the liquid outlet with respect to the horizontal.

2. A beverage production device according to claim 1, wherein the air outlet is positioned at the highest vertical point of the chamber.

3. A beverage production device according to claim 1, wherein the air outlet and the liquid outlet of the heater chamber are sufficiently distant so that air is not sucked by the water flow through the water outlet.

4. A beverage production device according to claim 1, wherein the heater chamber is tilted so that the air outlet is at a position higher than the liquid outlet with respect to the horizontal.

5. A beverage production device according to claim 1, wherein the heater chamber is tilted so that the air outlet is at or near the highest position of the heater chamber.

6. A beverage production device according to claim 4, wherein the heater chamber is tilted so that its longitudinal axis presents an angle with the vertical axis of at least 1°.

7. A beverage production device according to claim 1, wherein the heater chamber presents essentially the shape of a cylinder, the cylinder being truncated on at least its upper base, and the air outlet of the heater chamber is positioned on the upper truncated base of the chamber cylinder.

8. A beverage production device according to claim 7, wherein the heater chamber cylinder is truncated by a plane presenting an angle with the plane perpendicular to the chamber longitudinal axis of at least 1°.

9. A beverage production device according to claim 1, wherein the liquid inlet and the liquid outlet of the heater chamber are positioned at opposite parts of the chamber.

10. A beverage production device according to claim 1, wherein the liquid outlet is provided with a liquid valve and the air outlet is provided with an airvalve.

11. A beverage production device to claim 1, wherein the pressure to open the liquid valve is greater than that of the air valve.

12. A beverage production device according to claim 1, wherein the heater is provided with a temperature sensor.

13. A beverage production device according to claim 1, wherein the heating body is operatively connected to a temperature sensor.

14. A beverage production device according to claim 1, wherein the heating body has the shape of a spiral and the heater chamber is hollowed along its central axis so as to form a ring in which the spiral fits.

15. A beverage production device according to claim 1, wherein:
the air outlet is provided with an air valve;
the heater is provided with a temperature sensor;
the heating body has the shape of a spiral and the heater chamber is hollowed along its central axis so as to form a ring in which the spiral fits; and
the heater comprises a common bracket for attaching an outlet connector to the beverage production chamber, the air valve and the temperature sensor to the heater chamber.
